(19) United States
(12) Patent Application Publication
(10) Pub. No.: US 2026/0235724 A1
(43) Pub. Date: Aug. 13, 2026

(54) RADAR CALIBRATION SYSTEM AND RADAR CALIBRATION METHOD

(71) Applicant: Wistron Corporation, New Taipei City (TW)

(72) Inventors: Tsung Yin Tsou, New Taipei City (TW); Yao Tsung Chang, New Taipei City (TW); Yin Yu Chen, New Taipei City (TW); Kaijen Cheng, New Taipei City (TW)

(73) Assignee: Wistron Corporation, New Taipei City (TW)

(21) Appl. No.: 19/093,186

(22) Filed: Mar. 27, 2025

(30) Foreign Application Priority Data
Feb. 8, 2025 (TW) 114104731

(51) Int. Cl. G01S 7/40

(52) U.S. Cl. CPC G01S 7/4026; G01S 7/40

(57) ABSTRACT

Provided are a radar calibration system and a radar calibration method. The method includes: a first point cloud is obtained through a radar; a first fitting plane is generated according to the first point cloud; a second point cloud is obtained through the radar; a second fitting plane is generated according to the second point cloud; and a coordinate system of the radar is calibrated according to an included angle between the first fitting plane and the second fitting plane.

### CROSS-REFERENCE TO RELATED APPLICATION

This application claims the priority benefit of Taiwan application serial no. 114104731, filed on Feb. 8, 2025. The entirety of the above-mentioned patent application is hereby incorporated by reference herein and made a part of this specification.

### BACKGROUND

### Technical Field

The disclosure relates to a radar measurement technology, and in particular relates to a radar calibration system and a radar calibration method.

### Related Art

As the number of elderly people living alone is increasing nowadays, the demand for home care has also increased accordingly. Many home care systems utilize cameras or wearable devices to monitor the state of the care recipients. The method that utilizes images for monitoring might have disadvantages such as invasion of privacy or leakage of personal information.

In addition, most people do not like to be constrained by wearable devices or often forget to wear the wearable devices. To solve the foregoing problems, some home care systems utilize radars to monitor the care recipients. However, the radar might be tilted due to factors such as improper installation or external force, and lead to deviations in a coordinate system of a point cloud data obtained by the radar. Therefore, how to correctly calibrate the coordinate system of the radar is one of the important issues in the art.

### SUMMARY

The disclosure provides a radar calibration system and a radar calibration method, which can calibrate a coordinate system of a tilted radar.

An embodiment of the disclosure provides a radar calibration system, which includes a radar and a controller. The controller is communicatively connected to the radar. The controller is configured to: obtain a first point cloud through the radar; generate a first fitting plane according to the first point cloud; obtain a second point cloud through the radar; generate a second fitting plane according to the second point cloud; and calibrate a coordinate system of the radar according to an included angle between the first fitting plane and the second fitting plane.

An embodiment of the disclosure provides a radar calibration method, which includes: a first point cloud is obtained through a radar; a first fitting plane is generated according to the first point cloud; a second point cloud is obtained through the radar; a second fitting plane is generated according to the second point cloud; and a coordinate system of the radar is calibrated according to an included angle between the first fitting plane and the second fitting plane.

Based on the above, the radar calibration system of the disclosure may generate the fitting planes according to the point clouds collected by the radar, and determine whether the radar is tilted according to the fitting planes. If the radar is tilted, the radar calibration system may calibrate the coordinate system of the radar through using a rotation matrix or controlling an actuator without using additional sensors.

### BRIEF DESCRIPTION OF THE DRAWINGS

FIG. 1 is a schematic diagram of a radar calibration system according to an embodiment of the disclosure.

FIG. 2 is a top view of a field according to an embodiment of the disclosure.

FIG. 3 is a side view of a field according to an embodiment of the disclosure.

FIG. 4 is a front view of a field according to an embodiment of the disclosure.

FIG. 5 is a flow chart of a radar calibration according to an embodiment of the disclosure.

FIG. 6 is a top view of a radar and multiple reflectors according to an embodiment of the disclosure.

FIG. 7 is a flow chart of a radar calibration method according to an embodiment of the disclosure.

### DESCRIPTION OF THE EMBODIMENTS

In order to make the content of the disclosure more comprehensible, embodiments in which the disclosure may be implemented are listed as follows. In addition, wherever possible, elements/components/steps with the same reference numerals in the drawings and embodiments represent the same or similar components.

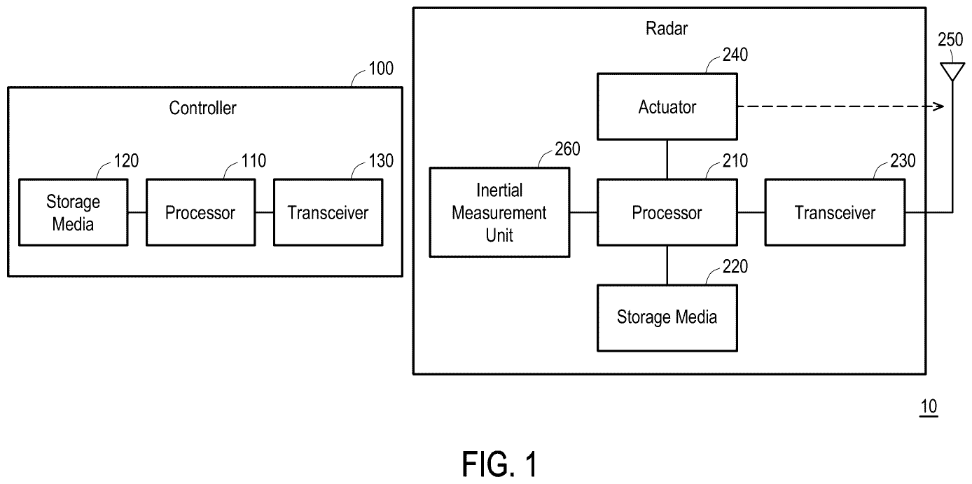

FIG. 1 is a schematic diagram of a radar calibration system 10 according to an embodiment of the disclosure. The radar calibration system 10 may include a controller 100 and a radar 200. The controller 100 may be communicatively connected to the radar 200 and elements in the radar 200. In an embodiment, the controller 100 may be embedded in the radar 200.

The controller 100 may include a processor 110, a storage media 120, and a transceiver 130. The processor 110 may be, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), or other similar elements or combinations of the foregoing elements. The processor 110 may be coupled to the storage media 120 and the transceiver 130, and access and execute multiple modules and various applications stored in the storage media 120.

The storage media 120 may be, for example, any type of fixed or movable random access memory (RAM), read-only memory (ROM), flash memory, hard disk drive (HDD), solid state drive (SSD), or similar elements or combinations of the foregoing elements, and is configured to store multiple modules or various applications that may be executed by the processor 110.

The transceiver 130 transmits or receives a signal in a wireless or wired manner. The transceiver 130 may further execute operations such as low-noise amplification, impedance matching, mixing, up or down frequency conversion, filtering, amplification, and the like.

The radar 200 may be, for example, a frequency modulated continuous wave (FMCW) radar. The radar 200 may detect an object in a field within a coverage range to generate a point clouds or a bounding box corresponding to the object (such as a wall, ceiling, or obstacle in the field), and obtain a centroid or center of gravity information of the point cloud. The radar 200 may include a processor 210, a storage media 220, a transceiver 230, an actuator 240, and an antenna 250. In an embodiment, the radar 200 may further include an inertial measurement unit (IMU) 260.

The processor 210 may be, for example, a CPU, or other programmable general-purpose or special-purpose MCU, microprocessor, DSP, programmable controller, ASIC, GPU, ISP, IPU, ALU, CPLD, FPGA, or other similar elements or combinations of the foregoing elements. The processor 210 may be coupled to the storage media 220, the transceiver 230, the actuator 240, and the inertial measurement unit 260, and access and execute multiple modules and various applications stored in the storage media 220. When the controller 100 is embedded in the radar 200, the processor 210 and the controller 100 (or the processor 110) may be the same hardware device. The processor 210 (or the controller 100) may analyze a point cloud obtained by the radar 200 to determine a movement path, instantaneous velocity, average velocity, dwell time in specific regions, or human activity information of an object according to a time information and a position information.

The storage media 220 may be, for example, any type of fixed or movable RAM, ROM, flash memory, HDD, SSD, or similar elements or combinations of the foregoing elements, and is configured to store multiple modules or various applications that may be executed by the processor 210.

The transceiver 230 transmits or receives a signal in a wireless or wired manner. The transceiver 230 may further execute operations such as low-noise amplification, impedance matching, mixing, up or down frequency conversion, filtering, amplification, and the like. The transceiver 230 may be coupled to the antenna 250, and transmit or receive a wireless signal through the antenna 250, and generate a point cloud.

The actuator 240 may include, for example, mechanical structures such as motors. The actuator 240 may be configured to rotate the antenna 250, and rotate a coordinate system of the radar 200 with the antenna 250 as a reference point.

The inertial measurement unit 260 may be, for example, an accelerometer, a three-axis sensor, a six-axis sensor, or a nine-axis sensor. The inertial measurement unit 260 may detect an acceleration of the radar 200 in a specific direction. The controller 100 or the processor 210 may determine whether the radar 200 is tilted according to a measurement result from the inertial measurement unit 260.

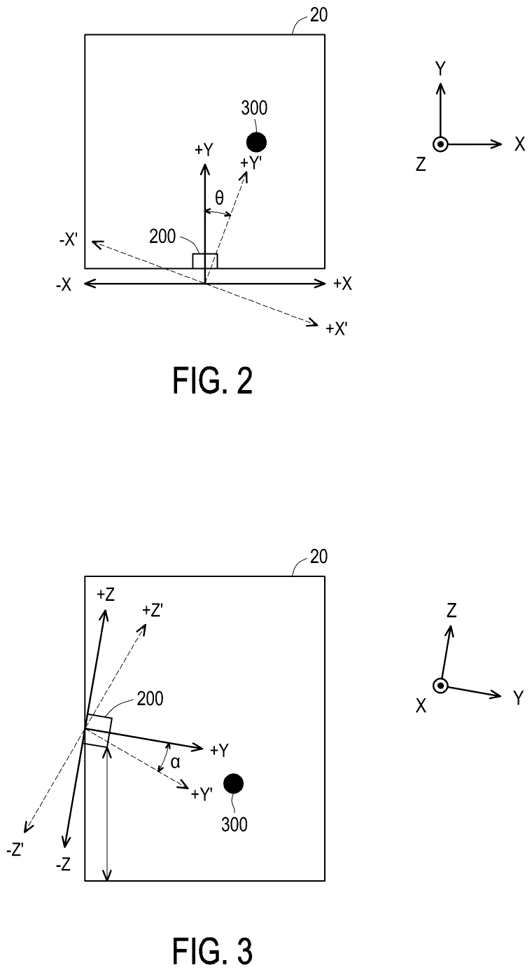

FIG. 2 is a top view of a field 20 according to an embodiment of the disclosure. When the radar 200 is correctly installed on a wall surface (that is, an XZ plane), three axes of an original coordinate system (such as a Cartesian coordinate system) of the radar 200 are respectively an X-axis, a Y-axis, and a Z-axis. An object 300 is located to the front right of the radar 200, and the coordinates of the object 300 in the original coordinate system are (Xₜ, Yₜ). When the radar 200 is rotated clockwise by an angle θ due to factors such as improper installation or external force, the three axes of the coordinate system of the radar 200 become an X′-axis, a Y′-axis, and a Z′-axis. The coordinates of the object 300 may transform to be (X′t, Y′t), leading the object 300 to be misjudged as being located directly in front of the radar 200.

FIG. 3 is a side view of the field 20 according to an embodiment of the disclosure. When the radar 200 is correctly installed on a wall surface (that is, an XZ plane), three axes of an original coordinate system of the radar 200 are respectively an X-axis, a Y-axis, and a Z-axis. When the radar 200 is tilted downward due to factors such as improper installation or external force, the three axes of the coordinate system of the radar 200 become an X′-axis, a Y′-axis, and a Z′-axis, where a is an angle between the Y′-axis and the Y-axis. The coordinates of the object 300 in the coordinate system may change, and lead the object 300 to be misjudged as being at a higher position.

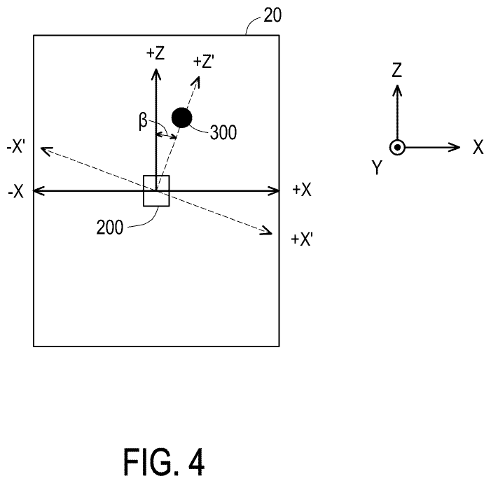

FIG. 4 is a front view of the field 20 according to an embodiment of the disclosure. When the radar 200 is correctly installed on a wall surface (that is, an XZ plane), three axes of an original coordinate system of the radar 200 are respectively an X-axis, a Y-axis, and a Z-axis. The object 300 is located to the upper right of the radar 200, and the coordinates of the object 300 in the original coordinate system are (Xₜ, Zₜ). When the radar 200 is rotated clockwise by an angle β due to factors such as improper installation or external force, the three axes of the coordinate system of the radar 200 become an X′-axis, a Y′-axis, and a Z′-axis. The coordinates of the object 300 may transform to be (X′ₜ, Z′ₜ), leading the object 300 to be misjudged as being located directly above the radar 200.

After the radar 200 is tilted, a point cloud data of a fixed object around the radar 200 may be changed. For example, a point cloud corresponding to a vertical wall may no longer be presented as a vertical plane, but presented as a tilted plane. Assume the radar 200 is horizontally installed and facing a vertical wall. When the radar 200 is not tilted, a plane equation of the vertical wall is x=0. When the radar 200 is tilted and leads the coordinate system of the radar 200 to be rotated along the Y-axis, the plane equation of the vertical wall may change to be x=az+b, where a is a tilt slope of the vertical wall. The controller 100 may calculate a tilt angle of the radar 200 as θ=arctan(a) according to the change in the plane equation.

Assume the radar 200 is tilted around the Y-axis of the original coordinate system. After θ is determined, the controller 100 may convert the coordinate system of the radar 200 back to the original coordinate system when the radar 200 was not tilted according to a rotation matrix Ry(θ) as shown in formula (1).

$$R y ( θ ) = [ \begin{matrix}cos ( θ ) & 0 & - sin ( θ ) \\ 0 & 1 & 0 \\ sin ( θ ) & 0 & cos ( θ )\end{matrix} ] \qquad ( 1 )$$

The controller 100 may use the rotation matrix Ry(θ) to convert the coordinates (x, y, z) of the point cloud detected by the tilted radar 200 to coordinates (x′, y′, z′) that is not tilted as shown in formula (2).

$$[ \begin{matrix}{x}^{′} \\ {y}^{′} \\ {z}^{′}\end{matrix} ] = R y ( θ ) \cdot [ \begin{matrix}x \\ y \\ z\end{matrix} ] \qquad ( 2 )$$

On the other hand, the controller 100 may rotate the antenna 250 of the radar 200 through the actuator 240, and adjust a beam direction of the radar 200.

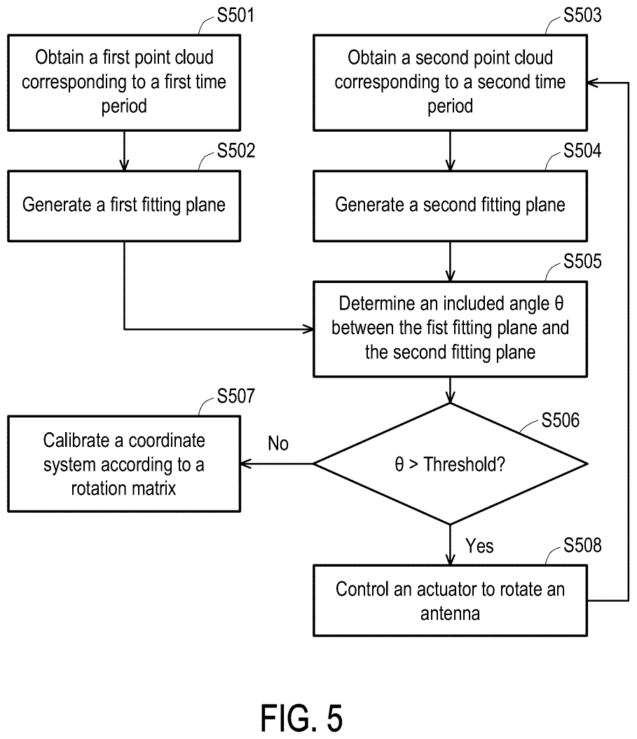

FIG. 5 is a flow chart of a radar calibration according to an embodiment of the disclosure. The steps of the flow chart may be implemented by the radar calibration system 10 as shown in FIG. 1.

In step S501, the controller 100 may obtain a first point cloud corresponding to a first time period (such as a time period when the radar 200 has not yet been tilted) through the radar 200.

In step S502, the controller 100 may generate a first fitting plane according to the first point cloud. In an embodiment, the controller 110 may filter a dynamic point cloud (such as a point cloud of a person or a pet) from the first point cloud and retain a static point cloud (such as a point cloud of a wall or a floor) to update the first point cloud. After the first point cloud is updated, the controller 100 may generate the first fitting plane according to an updated first point cloud. For example, the controller 100 may generate a first fitting plane x=0 corresponding to a wall facing the radar 200 according to the first point cloud.

In an embodiment, the processor 110 may execute a random sample consensus (RANSAC) algorithm on the point cloud to generate a fitting plane.

In step S503, the controller 100 may obtain a second point cloud corresponding to a second time period (such as a time period when the radar 200 has already been tilted) through the radar 200. The second time period is later than the first time period.

In an embodiment, the controller 100 may periodically control the radar 200 to perform scanning to obtain the second point cloud, and may determine whether the radar 200 is tilted according to the second point cloud. In an embodiment, the controller 100 may determine whether the radar 200 is tilted according to a measurement result of the inertial measurement unit 260. If the controller 100 determines that the radar 200 has been tilted, the controller 100 may obtain the second point cloud through the radar 200 based on a triggering of the measurement result.

In step S504, the controller 100 may generate a second fitting plane according to the second point cloud. In an embodiment, the controller 110 may filter a dynamic point cloud from the second point cloud and retain a static point cloud to update the second point cloud. After the second point cloud is updated, the controller 100 may generate the second fitting plane according to an updated second point cloud.

In step S505, the controller 100 may determine an included angle θ between the first fitting plane and the second fitting plane.

In step S506, the controller 100 may determine whether the included angle θ is greater than a threshold. If the included angle θ is greater than the threshold, the controller 100 may execute step S508 to adjust the coordinate system of the radar 200 to a greater degree. If the angle θ is less than or equal to the threshold, the controller 100 may execute step S507 to adjust the coordinate system of the radar 200 to a lesser degree.

In step S507, the controller 100 may generate a rotation matrix according to the angle θ, and calibrate the coordinate system of the radar 200 according to the rotation matrix. After the calibration is completed, a point cloud output by the radar 200 may have correct coordinates.

In step S508, the controller 100 may control the actuator 240 to rotate the antenna 250 according to the included angle θ to reduce a substantial tilt angle of the radar 200. In an embodiment, after step S508 is completed, the controller 100 may re-execute step S503 to step S507 to fine-tune the coordinate system of the radar 200. After the calibration is completed, a point cloud output by the radar 200 may have correct coordinates.

For example, after the tilt has occurred, points captured by the radar 200 from a wall facing the radar 200 (such as a wall corresponding to the first fitting plane x=0) are shown in Table 1. The points in Table 1 shows that the wall is no longer a vertical plane (that is, a plane of x=0) but a tilted plane. The controller 110 generates a tilted plane equation x=0.1z+0.1 according to the points to serve as the second fitting plane. The controller 110 may calculate the included angle θ=arctan(0.1)≈5.71° between the first fitting plane and the second fitting plane according to the first fitting plane x=0 and the second fitting plane equation x=0.1z+0.1. The controller 110 may use a rotation matrix) Rx(5.71° to execute a coordinate conversion on the point clouds. For example, for point cloud coordinates (0.3, 3, 2) obtained after the radar 200 is tilted, the controller 100 may use the rotation matrix Rx(5.71°) to convert the coordinates (0.3, 3, 2) to coordinates (0.1, 3, 2.02) corresponding to the radar 200 that is not tilted.

TABLE 1

| Point Index | X-coordinate | Y-coordinate | Z-coordinate |
|---|---|---|---|
| 1 | 0.1 | 2 | 0 |
| 2 | 0.2 | 2.5 | 1 |
| 3 | 0.3 | 3 | 2 |
| 4 | 0.4 | 3.5 | 3 |

In an embodiment, the radar calibration system 100 may further include one or more reflectors disposed within a coverage range of the radar 200. The reflector may include but is not limited to a corner reflector. The reflector is disposed at a fixed position in the field. When the radar 200 scans the reflector, a reflection point corresponding to the reflector has a higher energy. The point with higher energy may assist the controller 100 or the radar 200 in positioning (such as positioning the reflector or a disposal position of the reflector).

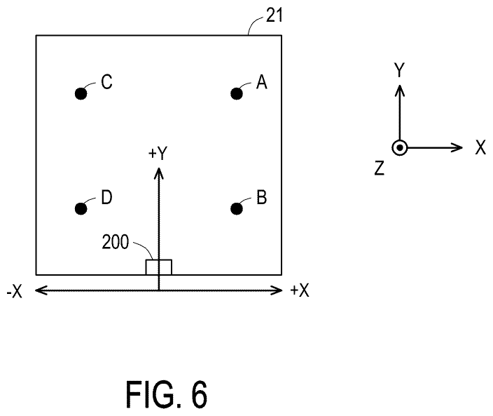

In an embodiment, at least four reflectors are disposed within the coverage range of the radar 200. FIG. 6 is a top view of the radar 200 and multiple reflectors (reflectors A, B, C, and D) according to an embodiment of the disclosure. The controller 110 may position surrounding objects or fitting planes thereof based on multiple positions of the multiple reflectors. For example, the controller 110 may position a viewing direction (such as a wall 21) faced by the radar 200 according to the multiple positions of the reflectors A, B, C, and D.

The controller 110 may calculate multiple distances between the reflectors according to the multiple positions of the reflectors A, B, C, and D, including A̅B̅, B̅C̅, D̅A̅, A̅C̅, B̅D̅, and D̅C̅. After the reflector D is moved, the distances D̅A̅, B̅D̅, and D̅C̅ corresponding to the reflector D may change. The controller 110 may correspond to other reflectors (such as the reflectors A, B, or C) with unchanged distances (such as A̅B̅, B̅C̅, or A̅C̅) as reference points to position the surrounding objects or the fitting planes thereof, or to calibrate the position of the reflector D.

For example, assume that the positions of the reflectors A, B, C, and D in the original coordinate system are respectively A=(1, 3, 0), B=(1, 1, 0), C=(−1, 3, 0), and D=(−1, 1, 0). The controller 110 may calculate the multiple distances A̅B̅=2, B̅C̅=2\sqrt{2}, D̅A̅=2\sqrt{2}, A̅C̅=2, B̅D̅=2, and D̅C̅=2 between the reflectors according to the multiple positions of the reflectors A, B, C, and D. Assume that the reflector D is moved in a direction 1 opposite to the radar 200 and leads the coordinates of the reflector D to be changed to D=(−1, 2, 0). The multiple distances between the reflectors may be changed to A̅B̅=2, B̅C̅=2\sqrt{2}, D̅A̅=\sqrt{5}, A̅C̅=2, B̅D̅=\sqrt{5}, D̅C̅=1. The controller 100 may determine that the distances D̅A̅, B̅D̅ and D̅C̅ have changed, so the reflector D may no longer serve as a reference point.

On the other hand, the controller 100 may determine that the distances A̅B̅, B̅C̅, and A̅C̅ have not changed, so the reflector A, the reflector B, and the reflector C may still serve as reference points. The controller 100 may take the unmoved reflectors A, B, and C as reference points to position the surrounding objects or the fitting planes thereof, such as positioning a viewing direction that the radar 200 faces.

In an embodiment, the controller 100 may take the unmoved reflectors A, B, and C as reference points to calculate a tilt angle to calibrate the coordinate system, thereby calculating new coordinates of the reflector D. For example, the controller 100 may execute triangulation according to the coordinates of each of the reflectors A, B, and C and the distances between each of the reflectors A, B, and C and the reflector D to calculate the coordinates of the reflector D.

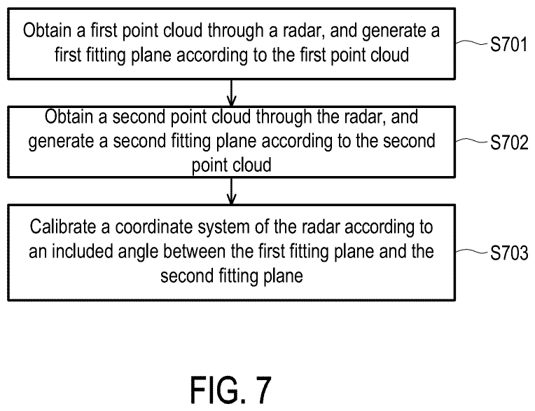

FIG. 7 is a flow chart of a radar calibration method according to an embodiment of the disclosure. The radar calibration method may be implemented by the radar calibration system 10 as shown in FIG. 1. In step S701, a first point cloud is obtained through a radar, and a first fitting plane is generated according to the first point cloud. In step S702, a second point cloud is obtained through the radar, and a second fitting plane is generated according to the second point cloud. In step S703, a coordinate system of the radar is calibrated according to an included angle between the first fitting plane and the second fitting plane.

In summary, the radar calibration system of the disclosure may determine whether the radar is tilted when installed on a wall surface, a wall corner, or a ceiling according to the point cloud collected by the radar. If the radar is tilted, the radar calibration system may calibrate the coordinate system of the radar according to a tilt angle. When the tilt angle is smaller, the radar calibration system may use a rotation matrix to calibrate the coordinate system. When the tilt angle is too large, the radar calibration system may control the actuator of the radar to rotate the antenna of the radar, and significantly reduce a substantial tilt angle of the radar. Furthermore, when a reflector disposed within a coverage range of the radar to assist the radar in positioning is moved, the radar calibration system may calibrate a position information of the moved reflector according to the distances between the multiple reflectors and the radar.

What is claimed is:

1. A radar calibration system, comprising:
a radar; and
a controller, communicatively connected to the radar, wherein the controller is configured to:
obtain a first point cloud through the radar;
generate a first fitting plane according to the first point cloud;
obtain a second point cloud through the radar;
generate a second fitting plane according to the second point cloud; and
calibrate a coordinate system of the radar according to an included angle between the first fitting plane and the second fitting plane.

2. The radar calibration system according to claim 1, wherein the controller is configured to:
determine whether the included angle is greater than a threshold;
generate a rotation matrix according to the included angle in response to the included angle being less than or equal to the threshold; and
calibrate the coordinate system according to the rotation matrix.

3. The radar calibration system according to claim 1, wherein the radar comprises an actuator and an antenna, wherein the controller is communicatively connected to the actuator, and is configured to further:
determine whether the included angle is greater than a threshold; and
control the actuator to rotate the antenna according to the included angle in response to the included angle being greater than the threshold.

4. The radar calibration system according to claim 1, further comprising:
a reflector, disposed in a coverage range of the radar,
wherein the controller positions the reflector according to an energy of a reflection point corresponding to the reflector in the first point cloud.

5. The radar calibration system according to claim 1, further comprising:
at least four reflectors, respectively disposed in a coverage range of the radar, wherein the controller positions the first fitting plane according to a plurality of positions of the at least four reflectors.

6. The radar calibration system according to claim 5, wherein the controller is configured to further:
calculate a plurality of distances between the at least four reflectors according to the plurality of positions;
determine whether a first distance corresponding to a first reflector among the plurality of distances has changed;
determine whether a second distance corresponding to a second reflector among the plurality of distances has changed; and
calibrate a first position of the first reflector with the second reflector as a reference point in response to the first distance changing but the second distance not changing.

7. The radar calibration system according to claim 5, wherein the controller is configured to further:
calculate a plurality of distances between the at least four reflectors according to the plurality of positions, wherein the at least four reflectors comprise a first reflector, a second reflector, a third reflector, and a fourth reflector;
determine whether a distance set corresponding to the first reflector among the plurality of distances has changed;
determine whether other distances among the plurality of distances except for the distance set have changed; and
position the first fitting plane with the second reflector, the third reflector, and the fourth reflector as reference points in response to the distance set changing but the other distances not changing.

8. The radar calibration system according to claim 1, wherein the first point cloud corresponds to a first time period, and the second point cloud corresponds to a second time period later than the first time period.

9. The radar calibration system according to claim 1, wherein the radar comprises:
an inertial measurement unit, communicatively connected to the controller, and generating a measurement result,
wherein the measurement result triggers the controller to obtain the second point cloud.

10. The radar calibration system according to claim 1, wherein the controller is configured to further:
filter a dynamic point cloud in the first point cloud to update the first point cloud;
filter a dynamic point cloud in the second point cloud to update the second point cloud; and
calculate the included angle according to an updated first point cloud and an updated second point cloud.

11. A radar calibration method, comprising:
obtaining a first point cloud through a radar;
generating a first fitting plane according to the first point cloud;
obtaining a second point cloud through the radar;
generating a second fitting plane according to the second point cloud; and
calibrating a coordinate system of the radar according to an included angle between the first fitting plane and the second fitting plane.

12. The radar calibration method according to claim 11, wherein the step of calibrating the coordinate system of the radar according to the included angle between the first fitting plane and the second fitting plane comprises:
determining whether the included angle is greater than a threshold;
generating a rotation matrix according to the included angle in response to the included angle being less than or equal to the threshold; and
calibrating the coordinate system according to the rotation matrix.

13. The radar calibration method according to claim 11, wherein the radar comprises an actuator and an antenna, wherein the step of calibrating the coordinate system of the radar according to the included angle between the first fitting plane and the second fitting plane comprises:
determining whether the included angle is greater than a threshold; and
controlling the actuator to rotate the antenna according to the included angle in response to the included angle being greater than the threshold.

14. The radar calibration method according to claim 11, further comprising:
positioning a reflector according to an energy of a reflection point corresponding to the reflector in the first point cloud, wherein the reflector is disposed in a coverage range of the radar.

15. The radar calibration method according to claim 11, wherein the step of generating the first fitting plane according to the first point cloud comprises:
positioning the first fitting plane according to a plurality of positions of at least four reflectors, wherein the at least four reflectors are respectively disposed in a coverage range of the radar.

16. The radar calibration method according to claim 15, further comprising:
calculating a plurality of distances between the at least four reflectors according to the plurality of positions;
determining whether a first distance corresponding to a first reflector among the plurality of distances has changed;
determining whether a second distance corresponding to a second reflector among the plurality of distances has changed; and
calibrating a first position of the first reflector with the second reflector as a reference point in response to the first distance changing but the second distance not changing.

17. The radar calibration method according to claim 15, further comprising:
calculating a plurality of distances between the at least four reflectors according to the plurality of positions, wherein the at least four reflectors comprise a first reflector, a second reflector, a third reflector, and a fourth reflector;
determining whether a distance set corresponding to the first reflector among the plurality of distances has changed;
determining whether other distances among the plurality of distances except the distance set have changed; and
positioning the first fitting plane with the second reflector, the third reflector and the fourth reflector as reference points in response to the distance set changing but the other distances not changing.

18. The radar calibration method according to claim 11, wherein the first point cloud corresponds to a first time period, and the second point cloud corresponds to a second time period later than the first time period.

19. The radar calibration method according to claim 11, wherein the step of obtaining the second point cloud through the radar comprises:
generating a measurement result through an inertial measurement unit; and
obtaining the second point cloud in response to a triggering of the measurement result.

20. The radar calibration method according to claim 11, further comprising:
filtering a dynamic point cloud in the first point cloud to update the first point cloud;
filtering a dynamic point cloud in the second point cloud to update the second point cloud; and
calculating the included angle according to an updated first point cloud and an updated second point cloud.
